(19) United States
(12) Patent Application Publication
(10) Pub. No.: US 2018/0176954 A1
(43) Pub. Date: Jun. 21, 2018

(54) CLEAR CHANNEL ASSESSMENT FOR SIMULTANEOUS TRANSMISION AND RECEPTION

(71) Applicant: INTEL CORPORATION, Santa Clara, CA (US)

(72) Inventors: Sarabjot SINGH, Santa Clara, CA (US); Shu-Ping YEH, New Taipei City (TW); Alexander W. MIN, Portland, OR (US)

(21) Appl. No.: 15/380,076

(22) Filed: Dec. 15, 2016

(51) Int. Cl. H04W 74/08

(52) U.S. Cl. CPC H04W 74/0816; H04W 84/12

(57) ABSTRACT

Access to unlicensed bands is typically preceded by a LBT or CCA mechanism, through which the transmitter determines the presence of ongoing transmissions in the same channel. Specifically, an AP or STA (prior to transmitting) senses the channel, and transmits only if the channel is adjudged to be idle. As mandated by the current IEEE 802.11 standard, the energy detected in the channel is compared with a predefined CCA threshold (signal detect threshold is −82 dBm and energy threshold is −62 dBm for 20 MHz OFDM transmission). This creates an RF-energy based guard zone around each transmitter and hence prevents any other transmitter from reusing the medium. To fully leverage simultaneous transmit and receive capability at an AP, it is desirable for the AP to simultaneously send downlink data to a STA while receiving UL data from another STA. However, with traditional CCA methods, the downlink transmission would be blocked.

### TECHNICAL FIELD

An exemplary aspect is directed toward communications systems. More specifically an exemplary aspect is directed toward wireless communications systems and even more specifically to interference management in wireless networks. Even more particularly, an exemplary aspect is directed toward full duplex (simultaneous transmit and receive—STR) communications.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

IEEE 802.11AC and other standards have proposed full duplex WiFi radios that can simultaneously transmit and receive on the same channel using standard WiFi 802.11ac PHYs. These radios achieve close to the theoretical doubling of throughput in all practical deployment scenarios.

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary full duplex environment;

FIG. 2 illustrates an exemplary full duplex environment with a modified CCA threshold;

FIG. 3 illustrates a block diagram of components for performing the techniques disclosed herein; and

FIG. 4 is a flowchart illustrating an exemplary method for updating a CCA threshold.

### DESCRIPTION OF EMBODIMENTS

Access to unlicensed bands is typically preceded by a “listen before talk” (LBT) or “clear channel assessment” (CCA) mechanism, through which the transmitter determines the presence of ongoing transmissions in the same channel. Specifically, an AP (Access Point) or STA (Station) (prior to transmitting buffered data) senses the (communications) channel, and transmits only if the channel is adjudged to be idle, i.e., the detected energy on the channel is below the CCA or LBT threshold. As mandated by the current IEEE 802.11 standard, the energy detected (or sensed) in the channel is compared with a predefined CCA threshold (signal detect threshold is −82 dBm and energy threshold is −62 dBm for 20 MHz OFDM transmission). This method creates an RF-energy based guard zone around each transmitter and hence prevents any other transmitter in this region from reusing the medium.

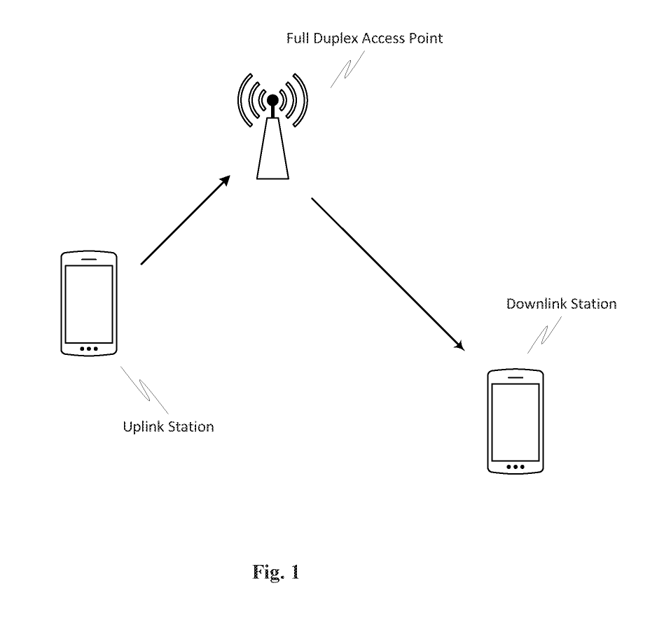

To fully leverage simultaneous transmit and receive (or full duplex) capability at an AP, it is desirable for the AP to simultaneously send downlink data to a STA while receiving UL data from another STA (as shown in FIG. 1). However, with traditional CCA methods at the AP, the downlink transmission would be blocked due to the received energy of the UL STA's transmission exceeding CCA threshold. At the same time, CCA cannot be completely avoided, as CCA is required to void any undesirable interference to an ongoing transmission at another AP or OBSS (Overlapping Basic Service Set).

Therefore, one exemplary key design problem is how to adapt the CCA procedure to allow for the AP to receive data from an UL STA, while transmitting data to a DL STA, without causing interference to neighbouring cells.

One exemplary aspect is directed toward a modification to the CCA procedure to allow a FD AP to receive from an UL STA and transmit to a DL STA while providing protection to other ongoing co-channel transmissions. There are other exemplary advantages to the use of this approach in that the use of RTS/CTS (Request to Send/Clear To Send) could incur large overhead and is usually avoided in practice.

In accordance with an exemplary aspect, the technique uses a modified energy detection threshold at the FD AP that allows the AP to multiplex an UL transmission with a DL transmission in absence of an interfering OBSS transmission.

The CCA threshold (CCAₜₕ) for the FD AP is increased by the amount of received signal energy from its UL STA, resulting in an updated CCA threshold (CCA′ₜₕ) i.e.:

CCA′ₜₕ=CCAₜₕ+R,

where R is the received signal energy from the AP's UL STA.

This technique allows the AP to ignore the received signal power from its own UL STA and isolate other interference sources for CCA.

Some of the exemplary advantages associated with this technique are that:
The full duplex AP can fully leverage the capacity gains opportunistically in the absence of other interfering transmissions.
There is no adverse impact to the co-existing legacy WiFi or LAA (Licensed-Assisted Access) STAs, since any ongoing transmissions are not ignored.

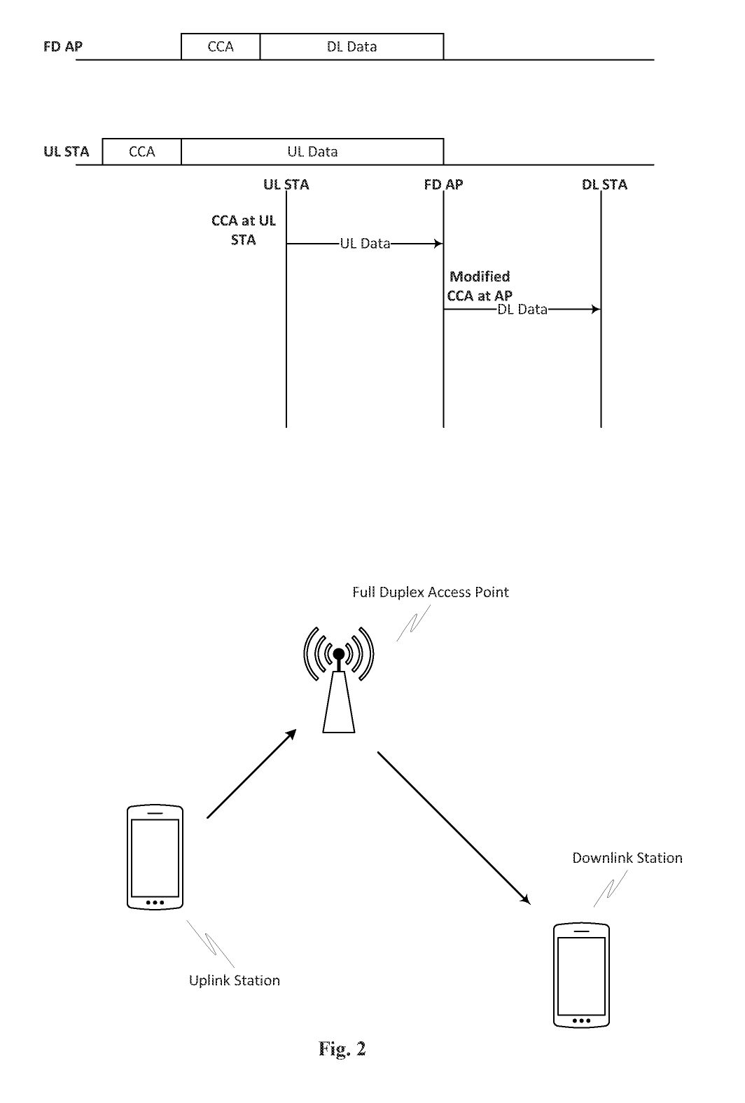

One exemplary modified method for clear channel assessment that allows FD APs to allow for simultaneous uplink (STA to AP) and downlink (AP to STA) transmissions is shown in FIG. 2. The exemplary technique utilizes an increased CCA threshold at the AP in the presence of an UL transmission. The CCA threshold (CCAₜₕ) for the FD AP can be increased by the amount of received signal energy from the AP's UL STA, i.e.,

CCA′ₜₕ=CCAₜₕ+R,

where R is the received signal energy from the AP's UL STA.

In operation, the AP makes a determination as to whether the AP is receiving on the uplink. If the AP is not receiving on the uplink, the AP uses the default technique for CCA. When however, the AP is receiving on the uplink, the AP switches to using the modified CCA discussed herein.

More particularly, and in the case where the UL STA uses RTS/CTS for UL transmission:
If the UL STA received a CTS frame from the FD-AP, then the UL STA can transmit an uplink frame and the AP can transmit a downlink frame without worrying about the potential interference from, for example, OBSS signals (hence no change is required at the AP/CCA because the channel is already secured at both UL STA and the FD-AP),
If the UL STA did not receive a CTS frame from the FD-AP, then the UL STA will not initiate the uplink frame transmission.

In the situation where the UL STA does not use RTS/CTS for UL transmission:
Note that, upon the receipt of the UL frame, interference, say Infinit, may present at the AP (e.g., OBSS signal); e.g., if no interference, then Infinit=0.
If the (OBSS) interference was above a certain threshold, Infinit>γ1, then the FD-AP may not be able to detect and/or decode the UL PPDU (i.e., UL transmission fails). In this case, there is no opportunity for full-duplex downlink transmission and no change required for the CCA.
If the (OBSS) interference was between certain thresholds, γ2>Infinit (>γ3; note that the lower threshold is optional), then the FD-AP may be able to detect and decode the UL PPDU (i.e., UL transmission success).
If NAV (Network Allocation Vector) was set at the FD-AP due to an OBSS signal, then the FD-AP refrains from transmitting downlink frame.
If NAV was not set at the FD-AP, then the FD-AP needs to (re-)evaluate the channel for potential (FD) downlink frame transmission. In this case, the AP may want to adjust the CCA threshold for potential FD downlink transmission, e.g.,

CCA′ₜₕ=CCAₜₕ+R

where CCAₜₕ is the default CCA threshold, and R is the measured received signal strength.

Such a modified CCA threshold can help detect any other additional (OBSS) signals which may occur between the UL frame reception and the FD DL frame transmission (the presence of additional interference may depend on the delay in preparing the FD DL transmission, including the time spent on UL frame MAC header decoding, identifying the FD opportunity, preparing the FD DL frame, etc.)

Measurement accuracy of the UL signal power (R).

The AP may only have a rough UL Rx (receive) power estimate, when the UL is transmitting in a higher MCS (Modulation and Coding Scheme) mode, such that it is possible that the fluctuation of the UL signal power is large which makes the CCA-ED estimation less accurate. In that case, an optional margin may be applied.

If the AP is capable of performing successive interference cancellation, the AP can optionally subtract the estimated UL signal from the total received signal to isolate the interfering signal and apply the default CCA threshold.

It should be noted that R, the measured received signal strength, can be determined in accordance with any of the known techniques for determining the received signal strength, with the techniques disclosed herein not limited by the type(s) of received signal strength technique used.

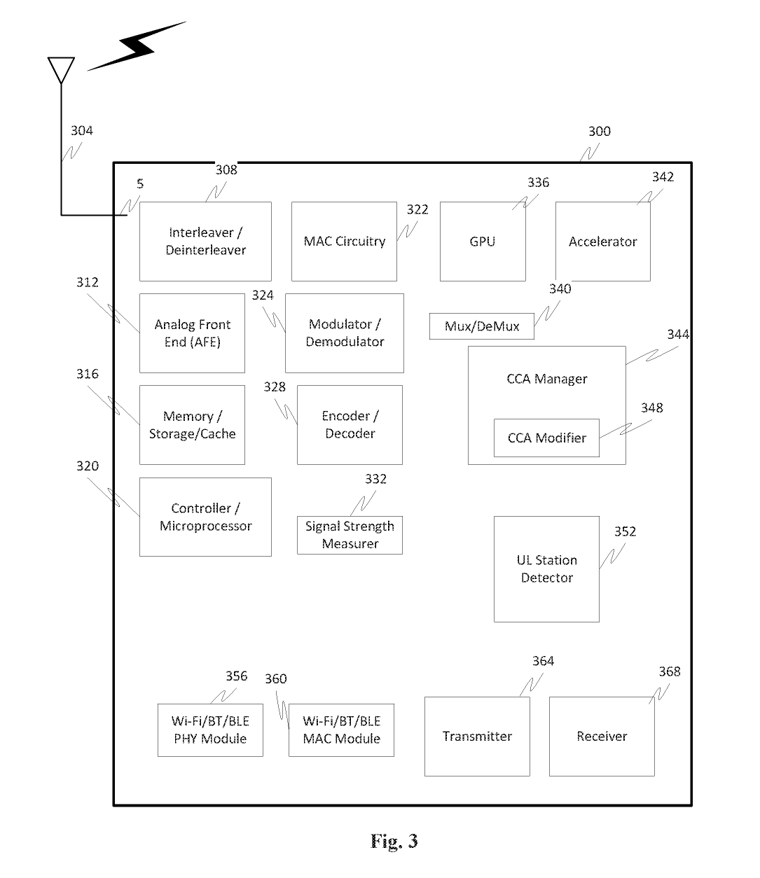

FIG. 3 illustrates an exemplary hardware diagram of a device 300, such as a wireless device, mobile device, access point, station, and/or the like, that is adapted to implement the technique(s) discussed herein. Operation will be discussed in relation to the components in FIG. 3 appreciating that each separate device in a system, e.g., station, AP, proxy server, etc., can include one or more of the components shown in the figure, with the components each being optional.

In addition to well-known componentry (which has been omitted for clarity), the device 300 includes interconnected elements (with links 5 omitted for clarity) including one or more of: one or more antennas 304, an interleaver/deinterleaver 308, an analog front end (AFE) 312, memory/storage/cache 316, controller/microprocessor 320, MAC circuitry 322, modulator/demodulator 324, encoder/decoder 328, signal strength measurer 332, GPU 336, accelerator 342, a multiplexer/demultiplexer 340, CCA Manager 344, CCA modifier 348, uplink station detector 352, a Wi-Fi/BT/BLE PHY module 356, a Wi-Fi/BT/BLE MAC module 360, transmitter 364 and receiver 368. The various elements in the device 300 are connected by one or more links (not shown, again for sake of clarity).

The device 300 can have one more antennas 304, for use in wireless communications such as multi-input multi-output (MIMO) communications, multi-user multi-input multi-output (MU-MIMO) communications Bluetooth®, LTE, RFID, 4G, LTE, etc. The antenna(s) 304 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 304 generally interact with the Analog Front End (AFE) 312, which is needed to enable the correct processing of the received modulated signal and signal conditioning for a transmitted signal. The AFE 312 can be functionally located between the antenna and a digital baseband system in order to convert the analog signal into a digital signal for processing and vice-versa.

The device 300 can also include a controller/microprocessor 320 and a memory/storage/cache 316. The device 300 can interact with the memory/storage/cache 316 which may store information and operations necessary for configuring and transmitting or receiving the information described herein. The memory/storage/cache 316 may also be used in connection with the execution of application programming or instructions by the controller/microprocessor 320, and for temporary or long term storage of program instructions and/or data. As examples, the memory/storage/cache 320 may comprise a computer-readable device, RAM, ROM, DRAM, SDRAM, and/or other storage device(s) and media.

The controller/microprocessor 320 may comprise a general purpose programmable processor or controller for executing application programming or instructions related to the device 300. Furthermore, the controller/microprocessor 320 can perform operations for configuring and transmitting information as described herein. The controller/microprocessor 320 may include multiple processor cores, and/or implement multiple virtual processors. Optionally, the controller/microprocessor 320 may include multiple physical processors. By way of example, the controller/microprocessor 320 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 300 can further include a transmitter 364 and receiver 368 which can transmit and receive signals, respectively, to and from other wireless devices and/or access points using the one or more antennas 304. Included in the device 300 circuitry is the medium access control or MAC Circuitry 322. MAC circuitry 322 provides for controlling access to the wireless medium. In an exemplary embodiment, the MAC circuitry 322 may be arranged to contend for the wireless medium and configure frames or packets for communicating over the wireless medium.

The PHY Module/Circuitry 356 controls the electrical and physical specifications for device 300. In particular, PHY Module/Circuitry 356 manages the relationship between the device 300 and a transmission medium. Primary functions and services performed by the physical layer, and in particular the PHY Module/Circuitry 356, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 356 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 322 handle co-ordination of interactions between the MAC and PHY layers.

The MAC layer and components, and in particular the MAC module 360 and MAC circuitry 322 provide functional and procedural means to transfer data between network entities and to detect and possibly correct errors that may occur in the physical layer. The MAC module 360 and MAC circuitry 322 also provide access to contention-based and contention-free traffic on different types of physical layers, such as when multiple communications technologies are incorporated into the device 300. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 300 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 342 can cooperate with MAC circuitry 322 to, for example, perform real-time MAC functions. The GPU 336 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In operation, the AP (e.g., 300), and in particular the UL station detector 352, makes a determination as to whether the AP is receiving on the uplink. If the AP is not receiving on the uplink, the AP uses whatever is the default technique for the CCA. When however, the AP is receiving on the uplink as determine by the UL station detector 352, the AP 300 switches to using the modified CCA with the cooperation of the CCA manager 344 and CCA modifier 348 with processor 320 and memory 316 as discussed herein.

More particularly, and in the case where the UL STA uses RTS/CTS for UL transmission:
If the UL STA received a CTS frame from the FD-AP transmitter 364, then the UL STA can transmit an uplink frame and the AP can transmit a downlink frame without worrying about the potential interference from, for example, OBSS signals (hence no change is required at the AP/CCA because the channel is already secured at both UL STA and the FD-AP),
If the UL STA did not receive a CTS frame from the FD-AP, then the UL STA will not initiate the uplink frame transmission.

In the situation where the UL STA does not use RTS/CTS for UL transmissions:
Note that, upon the receipt of the UL frame, interference as detected by the signal strength measurer 332, say Infinit, may present at the AP (e.g., OBSS signal); e.g., if no interference, then Infinit=0.
If the (OBSS) interference was above a certain threshold, Infinit>γ1, then the FD-AP may not be able to detect and/or decode the UL PPDU (i.e., UL transmission fails). In this case, there is no opportunity for full-duplex downlink transmission and no change required for the CCA.
If the (OBSS) interference was between certain thresholds, γ2>Infinit (>γ3; note that the lower threshold is optional), then the FD-AP may be able to detect and decode the UL PPDU with the encoder/decoder 328 (i.e., UL transmission success).
If the NAV (Network Allocation Vector) was set at the FD-AP due to an OBSS signal, then the FD-AP refrains from transmitting downlink frame.
If the NAV was not set at the FD-AP, then the FD-AP, and in particular the CCA manager 344, may (re-)evaluate the channel for potential (FD) downlink frame transmission. In this case, the AP, and in particular the CCA manager 344 and CCA modifier 348, may want to adjust the CCA threshold to an updated threshold CCA′ₜₕ for potential FD downlink transmission, in accordance with:

CCA′ₜₕ=CCAₜₕ+R

where CCAₜₕ is the default CCA threshold, and R is the measured received signal strength as determined by the signal strength measurer 332.

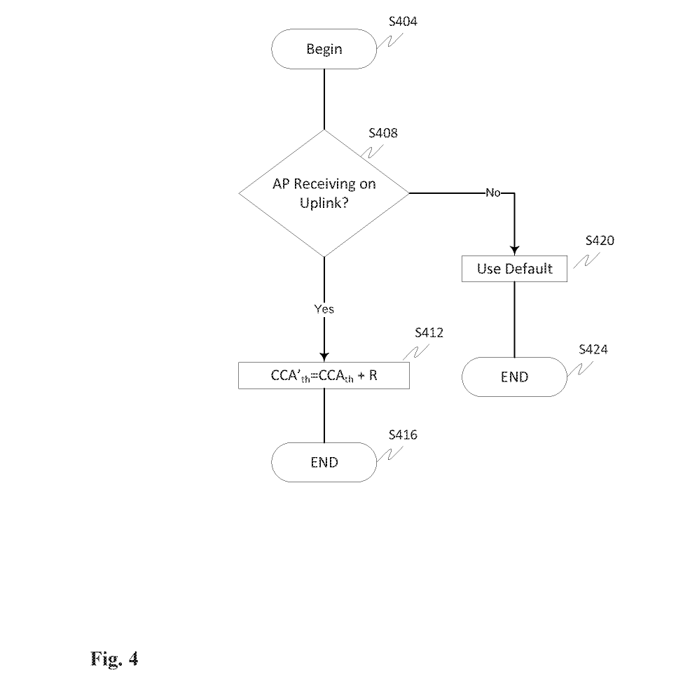

FIG. 4 provides an illustrative overview of a method for modifying the CCA as discussed herein. In particular control begins in step S404 and continues to step S408. In step S408 a determination is made whether the AP is receiving on the uplink channel. If the AP is receiving on the uplink channel control continues to step S412 with control otherwise continuing to step S420. In step S412, the CCA us updated to CCA′ₜₕ with control continuing to step S416 where the control sequence ends.

otherwise, control continues to step S420 where the default CCA for the AP is used. Control then continues to step S424 where the control sequence ends.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a processor in communication with uplink station detector that determine a presence of an uplink transmission from a station; and

a CCA manager that updates, when there is an uplink transmission, and based on an amount of received signal energy from the station, a clear channel assessment (CCA) threshold.
Any of the above aspects, wherein the updated CCA threshold allows simultaneous uplink and downlink communications.
Any of the above aspects, wherein updated CCA threshold protects other ongoing co-channel transmissions.
Any of the above aspects, wherein the modified CCA threshold allows better detection of other overlapping basic service set signals.
Any of the above aspects, wherein the CCA manager further applies a margin to the modified CCA.
Any of the above aspects, wherein the modified CCA threshold is determined in accordance with Modified CCA=CCAₜₕ+R, where CCAₜₕ is a default CCA threshold, and R is a measured received signal strength.
Any of the above aspects, wherein the wireless device is an access point.
Any of the above aspects, wherein the modified CCA threshold is used when the device is already receiving data from another wireless device.
Any of the above aspects, wherein the modified CCA threshold is higher than a default CCA.
Any of the above aspects, wherein the device operates in an unlicensed band.
A non-transitory information storage media having stored thereon one or more instructions, that when executed by one or more processors, cause a wireless device to perform a method comprising:
determining a presence of an uplink transmission from a station; and updating, when there is an uplink transmission, and based on an amount of received signal energy from the station, a clear channel assessment (CCA) threshold.
Any of the above aspects, wherein the updated CCA threshold allows simultaneous uplink and downlink communications.
Any of the above aspects, wherein updated CCA threshold protects other ongoing co-channel transmissions.
Any of the above aspects, wherein the modified CCA threshold allows better detection of other overlapping basic service set signals.
Any of the above aspects, wherein the CCA manager further applies a margin to the modified CCA.
Any of the above aspects, wherein the modified CCA threshold is determined in accordance with Modified CCA=CCAₜₕ+R, where CCAₜₕ is a default CCA threshold, and R is a measured received signal strength.
Any of the above aspects, wherein the wireless device is an access point.
Any of the above aspects, wherein the modified CCA threshold is used when the device is already receiving data from another wireless device.
Any of the above aspects, wherein the modified CCA threshold is higher than a default CCA.
A wireless communications device comprising:
means for determining a presence of an uplink transmission from a station; and
means for updating, when there is an uplink transmission, and based on an amount of received signal energy from the station, a clear channel assessment (CCA) threshold.
Any of the above aspects, wherein the updated CCA threshold allows simultaneous uplink and downlink communications.
Any of the above aspects, wherein updated CCA threshold protects other ongoing co-channel transmissions.
Any of the above aspects, wherein the modified CCA threshold allows better detection of other overlapping basic service set signals.
Any of the above aspects, wherein the CCA manager further applies a margin to the modified CCA.
Any of the above aspects, wherein the modified CCA threshold is determined in accordance with Modified CCA=CCAₜₕ+R, where CCAₜₕ is a default CCA threshold, and R is a measured received signal strength.
Any of the above aspects, wherein the wireless device is an access point.
Any of the above aspects, wherein the modified CCA threshold is used when the device is already receiving data from another wireless device.
Any of the above aspects, wherein the modified CCA threshold is higher than a default CCA.
Any of the above aspects, wherein the device operates in an unlicensed band.

Stations (STA)/AP equipped with simultaneous transmission and reception (STR) capabilities and operating in unlicensed bands require listen before talk (LBT) or clear channel assessment (CCA) like in IEEE 802.11 or LTE LAA, an exemplary technique uses a modified CCA threshold when the AP is already receiving data from another STA/AP.

The above aspect where the modified CCA threshold is higher than a default CCA threshold.

The above modified CCA threshold wherein the modified CCA threshold is higher than the default CCA threshold by the amount of received signal power.

Any of the above aspects where successive interference capability is used to subtract the received signal from the total received signal to isolate the interfering signal and applying the default CCA threshold to the interfering signal.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® CortexTMM processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a processor in communication with uplink station detector to determine a presence of an uplink transmission from a station; and
a CCA manager to update, when there is an uplink transmission, and based on an amount of received signal energy from the station, a clear channel assessment (CCA) threshold.

2. The device of claim 1, wherein the updated CCA threshold allows simultaneous uplink and downlink communications.

3. The device of claim 1, wherein updated CCA threshold protects other ongoing co-channel transmissions.

4. The device of claim 1, wherein the modified CCA threshold allows better detection of other overlapping basic service set signals.

5. The device of claim 1, wherein the CCA manager further applies a margin to the modified CCA.

6. The device of claim 1, wherein the modified CCA threshold is determined in accordance with Modified CCA=CCAₜₕ+R, where CCAₜₕ is a default CCA threshold, and R is a measured received signal strength.

7. The device of claim 1, wherein the wireless device is an access point.

8. The device of claim 1, wherein the modified CCA threshold is used when the device is already receiving data from another wireless device.

9. The device of claim 1, wherein the modified CCA threshold is higher than a default CCA.

10. The device of claim 1, wherein the device operates in an unlicensed band.

11. A non-transitory information storage media having stored thereon one or more instructions, that when executed by one or more processors, cause a wireless device to perform a method comprising:
determining a presence of an uplink transmission from a station; and
updating, when there is an uplink transmission, and based on an amount of received signal energy from the station, a clear channel assessment (CCA) threshold.

12. The media of claim 11, wherein the updated CCA threshold allows simultaneous uplink and downlink communications.

13. The media of claim 11, wherein updated CCA threshold protects other ongoing co-channel transmissions.

14. The media of claim 11, wherein the modified CCA threshold allows better detection of other overlapping basic service set signals.

15. The media of claim 11, wherein the CCA manager further applies a margin to the modified CCA.

16. The media of claim 11, wherein the modified CCA threshold is determined in accordance with Modified CCA=CCAₜₕ+R, where CCAₜₕ is a default CCA threshold, and R is a measured received signal strength.

17. The media of claim 11, wherein the wireless device is an access point.

18. The media of claim 11, wherein the modified CCA threshold is used when the device is already receiving data from another wireless device.

19. The media of claim 11, wherein the modified CCA threshold is higher than a default CCA.

20. A wireless communications device comprising:
means for determining a presence of an uplink transmission from a station; and
means for updating, when there is an uplink transmission, and based on an amount of received signal energy from the station, a clear channel assessment (CCA) threshold.
